(19) United States
(12) Patent Application Publication
(10) Pub. No.: US 2014/0207680 A1
(43) Pub. Date: Jul. 24, 2014

(54) SYSTEM AND METHOD FOR PROVIDING A MOBILE WALLET SHOPPING COMPANION APPLICATION

(71) Applicant: Capital One Financial Corporation, McLean, VA (US)

(72) Inventor: Jeremy REPHLO, Washington, DC (US)

(73) Assignee: Capital One Financial Corporation, McLean, VA (US)

(21) Appl. No.: 14/208,550

(22) Filed: Mar. 13, 2014

Related U.S. Application Data
(63) Continuation-in-part of application No. 13/441,505, filed on Apr. 6, 2012.
Application No. 13/441,505 is a continuation-in-part of application No. 13/653,759, filed on Oct. 17, 2012.
(60) Provisional application No. 61/789,273, filed on Mar. 15, 2013.
(60) Provisional application No. 61/570,275, filed on Dec. 13, 2011.
(60) Provisional application No. 61/547,910, filed on Oct. 17, 2011.
(60) Provisional application No. 61/547,910, filed on Oct. 17, 2011.

(51) Int. Cl. G06Q 20/32; G06Q 20/40

(52) U.S. Cl. CPC G06Q 20/322; G06Q 20/40
USPC 705/44

(57) ABSTRACT

A system and method in accordance with example embodiments may include systems and methods for providing a mobile wallet shopping companion application. In an example embodiment, a method for providing a mobile wallet shopping companion application includes, receiving, via a network, confirmation of a transaction using a financial account; receiving, via a network, data relating to both the financial account and a customer associated with the financial account; and transmitting, via a network, processing the data relating to the financial account and the customer associated with the financial account in order to create a tailored offer and/or targeted data for the customer.

### CROSS-REFERENCED APPLICATIONS

This application claims priority to U.S. Provisional Patent Application No. 61/789,273, filed on Mar. 15, 2013, the entire contents of which is incorporated herein by reference.

This application is a continuation-in-part of U.S. application Ser. No. 13/441,505, filed on Apr. 6, 2012, which claims priority to Provisional Application Nos. 61/570,275 filed Dec. 13, 2011, and 61/547,910, filed Oct. 17, 2011, the contents of which are incorporated herein by reference in their entirety.

This application is a continuation-in-part of U.S. application Ser. No. 13/653,759 filed Oct. 17, 2012, which claims priority to Provisional Application No. 61/547,910, filed Oct. 17, 2011, the contents of which are incorporated herein by reference in their entirety.

### FIELD OF THE DISCLOSURE

The present disclosure relates to systems and methods for providing a mobile wallet shopping companion application.

### BACKGROUND OF THE DISCLOSURE

Current digital wallet solutions do not offer a complete shopping experience in the sense that they only provide a user with payment capabilities. Users are not provided with any additional transaction-related material that may assist the user in future transactions with the same merchant or a related merchant. These and other drawbacks exist.

### SUMMARY OF THE DISCLOSURE

Various embodiments of the present disclosure provide systems and methods for providing a mobile wallet shopping companion application. Such embodiments provide users information on merchants in the surrounding area that they may be interested in purchasing from. The information can be presented either from the user requesting it or directly after a financial transaction. This information may be based in part on the user's past financial transactions in a certain financial account. Information in the financial account can be analyzed to determine matches between certain merchants. For example, if a user is determined to usually purchase products from Store A, a message will be presented to user that they might want to try to buy products from Store B, where Store B is a store frequented by users who also frequent Store A and is located in nearby proximity to the point of sale transaction. Deals or additional rewards associated with the user's financial account also may be pushed to the user if they decide to make a transaction at Store B. In various embodiments, the nearby merchants can be shown as a list or in a graphical interface.

Once the point of sale transaction has been executed (by a payment card, ecommerce, or mobile wallet), a user may be given an option to rate their transaction at the point of sale. Merchant ratings may also be used to determine which store a user is suggested to go to next. This may be implemented, for example, by a merchant API, where the merchant may specify the post-sale ratings content and receive the user feedback.

Also, once the point of sale transaction has been executed, a user may be notified of an upcoming event associated with the merchant. This event can be displayed with an option to add an event to, for example, the user's electronic calendar on a mobile device.

Also, once the point of sale transaction has been executed, a user may be presented a deal or coupon to use at the merchant or another merchant. This deal could be linked, for example, to a user's payment instrument, be a barcode/qr code to present, or some other method of enabling the discount to be redeemed. Upon authorization of a transaction the system will look at some data points to decide if the cardholder will receive an offer. These data points include the nature of the transaction just authorized, the location of the cardholder, and the cardholder's purchase history. If the marketing system has an offer for this cardholder, it will be presented to the user, for example, on the user's mobile device.

Also, once the point of sale transaction has been executed, a user may be presented with the option to follow the merchant through social media. For example, there could be options to follow on Twitter and like on Facebook. As a preview of the merchant's social media presence, there may be a brief description or snippet of the merchant's social media feed(s) presented to the user.

Also, once the point of sale transaction has been executed, a user may be presented with options to purchase more goods/services from the merchant through their device. For example, the user could be presented with the option to buy a car wash at a gas station after purchasing gas.

Also, once the point of sale transaction has been executed, a user may be presented with an option to sign up for the merchant's loyalty program if they are not a member. If the user is a member of the loyalty program and has not linked their card to their mobile wallet, they would be able to link to that program. The registration or linking to the merchant's loyalty program could be completed, for example, on the user's mobile device.

Also, once the point of sale transaction has been executed, a user may be given information on their financial spending. For example, the user may be told that they have spent some percentage more or less on similar transactions from the previous month (e.g. “you have spent 20% less at cafes since last month,” etc.). The user can also be provided with financial information associated with the absolute balance they have left in their financial account (e.g. “$817.07 credit available,” etc.).

In various examples ,the user may be presented with “fun facts” related to their transaction history. For example, this is the user's 10th visit to the store, or type of store, in the last month. The user would be able to share this fact on social media. Transactions may be parsed for general information associated with the users spending habits, such as frequenting a particular restaurant a certain number of times or buying goods from a certain group of vendors. The facts can be drawn not only from type and name of vendor, but also from geographic location of the vendor.

Rewards and deals can also be pushed to the user based on achievements/milestones that they have reached based on their financial history. This can be pushed by a vendor or through a rewards broker.

The user also may be given the opportunity to leave tips or comments on their experience with the merchant. Similarly, the user could have the opportunity to read tips or comments left by other users who had interacted with that merchant.

In an example embodiment, a method for providing a mobile wallet shopping companion application includes, receiving, via a network, confirmation of a transaction using a financial account; receiving, via a network, data relating to both the financial account and a customer associated with the financial account; and transmitting, via a network, processing the data relating to the financial account and the customer associated with the financial account in order to create a tailored offer for the customer.

The method may further include receiving geolocation data and including the geolocation data in the processing in order to create a tailored offer for the customer. The method may also include receiving data relating to a similar customer and including the similar customer data in the processing in order to create a tailored offer for the customer.

### BRIEF DESCRIPTION OF THE DRAWINGS

Various embodiments of the present disclosure, together with further objects and advantages, may best be understood by reference to the following description taken in conjunction with the accompanying drawings, in the several Figures of which like reference numerals identify like elements, and in which:

FIG. 1 depicts an example embodiment of a mobile wallet shopping companion system;

FIG. 2 depicts an example embodiment of a mobile wallet shopping companion system;

FIG. 3 depicts an example embodiment of a mobile wallet shopping companion interface on a mobile device;

FIG. 4 depicts an example embodiment of a mobile wallet shopping companion interface on a mobile device;

FIG. 5 depicts an example embodiment of a mobile wallet shopping companion method;

FIG. 6 depicts an example embodiment of a point of sale system;

FIG. 7 depicts an example card authorization system and method; and

FIG. 8 depicts an example embodiment of a mobile wallet shopping companion system.

### DETAILED DESCRIPTION OF THE EMBODIMENTS

The following description is intended to convey a thorough understanding of the embodiments described by providing a number of specific example embodiments and details involving systems and methods for providing a mobile wallet shopping application. It should be appreciated, however, that the present disclosure is not limited to these specific embodiments and details, which are examples only. It is further understood that one possessing ordinary skill in the art, in light of known systems and methods, would appreciate the use of the invention for its intended purposes and benefits in various embodiments, depending on specific design and other needs. A financial institution and system supporting a financial institution are used as examples for the disclosure. The disclosure is not intended to be limited to financial institutions only.

According to the various embodiments of the present disclosure, systems and methods enable a mobile wallet shopping application using a mobile device. The use of “mobile device” throughout the application is only by way of example, and the attachment may also be used with personal computers, televisions, gaming systems, or any other device capable of making a purchase connection.

The various embodiments of the mobile wallet shopping companion system and methods may be provided in an online environment, whereby, for example, a mobile device, such as a smartphone, could receive companion offers in “real-time” or near “real-time” via a communication network. The mobile wallet shopping companion solution could also be used in an offline manner, whereby a previously-provided transaction data could be used for a certain period of time, regardless of whether the smartphone is connected to a communication network at the time of use.

In an example embodiment, the mobile wallet shopping companion system and methods may include software and application programming interfaces (APIs) to enable the mobile device to participate in commercial transactions. Accordingly, the mobile device may include APIs to enable mobile contactless payments (using Near Filed Communications (“NFC”), barcodes, or the like), remote electronic payments, and person-to-person payments (both proximity and remote). The system and software may allow for multiple cards, accounts, or other information portions to be stored and may allow simultaneous access to all, or switch between the individual options.

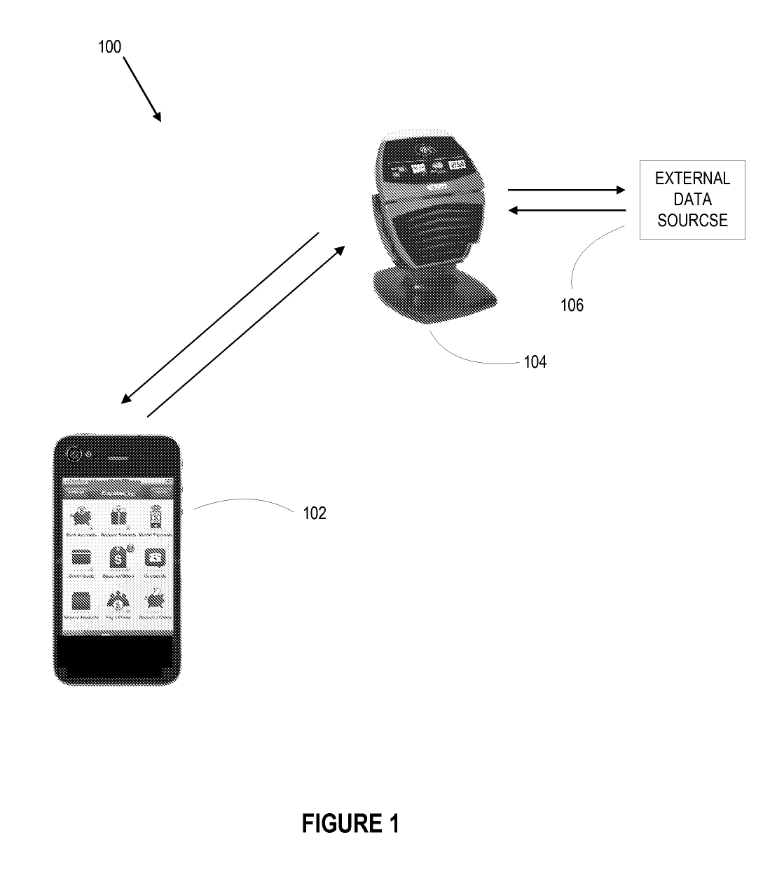

FIG. 1 depicts an example system 100 for use with the token-based software solution for payment that may include a mobile wallet companion application. In various embodiments, system 100 may operate as a conventional payment system that may not implement a token-based software solution. As depicted in FIG. 1, system 100 may include a mobile device 102, a point-of-sale (PoS) terminal 104, and external data sources 106. Mobile device 102 may be any mobile device capable of executing a payment. For example, mobile device 102 could be an iPhone, iPod, iPad from Apple® or any other mobile device running Apple's iOS operating system, any device running Google's Android® operating system including, for example, Google Glass, any device running Microsoft's Windows® Mobile operating system, and/or any other smartphone or like device.

Mobile device 102 may include for example, a Subscriber Identity Module (SIM) card, an NFC module, and an App Processor. The SIM card may be an integrated circuit that securely stores the service-subscriber key (IMSI) used to identify a subscriber on mobile telephony devices (such as mobile phones and computers). The NFC module may be an embedded NFC chip that can send encrypted data a short distance (“near field”) to a reader located, for instance, next to a retail cash register. The App Processor may enable execution of software applications on mobile device 102. In various embodiments, the app processor may cooperate with the NFC module to enable a payment using mobile device 102. Additionally, mobile device 102 may include an attachment for contactless payments (not shown), such as a contactless payment attachment that plugs into an audio jack or plug of a mobile device.

The App Processor of the mobile device 102 may enable executing of a mobile wallet shopping companion application, which may include various user interfaces. The mobile wallet shopping companion application and associated user interfaces may leverage transaction data, wireless data connection, over-the-air data connection, or other means of data transmission. The data used in the application may be transmitted , for example, from external data sources 106. For example, the application and user interface may leverage information about the products and/or services being purchased, information about the account or the account holder, information about the merchant and/or other parties involved in a transaction, rewards information, promotional information, advertising information, or other useful information.

Mobile device 102 may also include various software components to facilitate a mobile wallet shopping companion application For example, mobile device 102 may include an operating system such as, for example, the iOS operating system from Apple, the Google Android operating system, and the Windows Mobile operating system from Microsoft. Mobile device 102 may also include, without limitation, software applications such as mobile banking applications to facilitate a mobile wallet shopping companion application, an NFC application programming interface, and software to enable touch sensitive displays. Mobile device manufacturers may provide software stacks (e.g., APIs) which allow software applications to be written on top of the software stacks. For example, mobile device manufacturers may provide, without limitation, a card emulation API to enable NFC card emulation mode, a logic link control protocol (LLCP) API for peer-to-peer communication between mobile devices, and a real-time data (RTD) API and a NFC Data Exchange Format (NDEF) API for reading/writing.

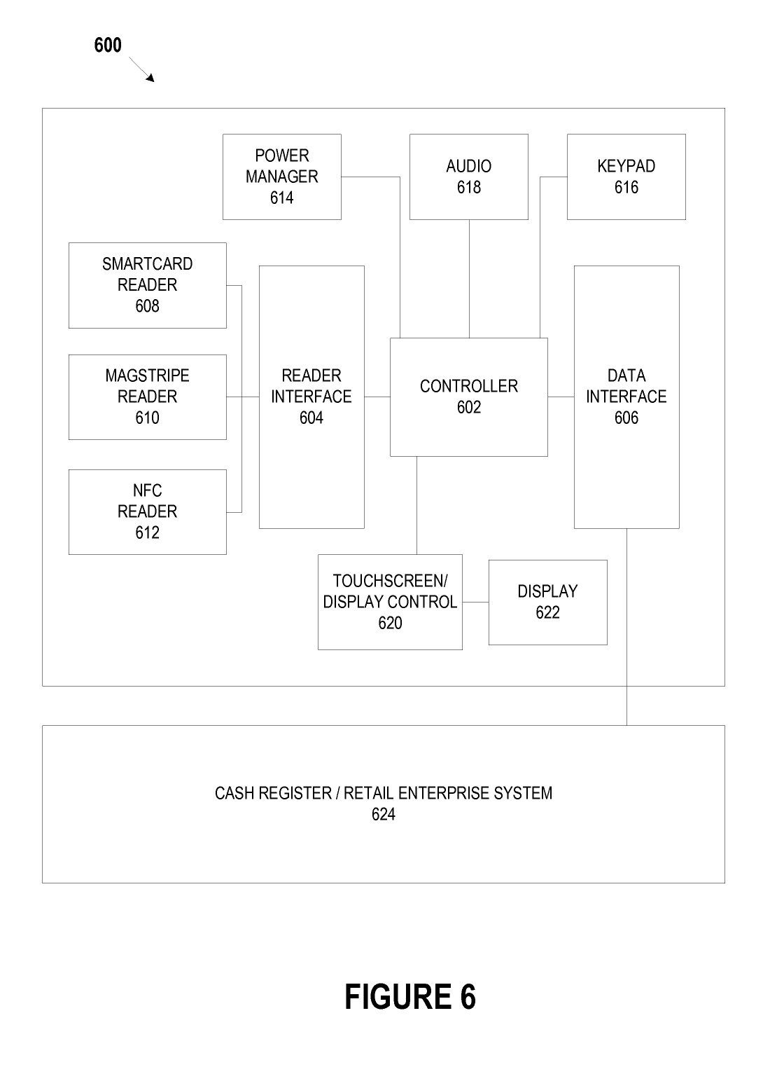

In various embodiments, PoS terminal 104 may be similar to PoS system 600 as shown and described in FIG. 6.

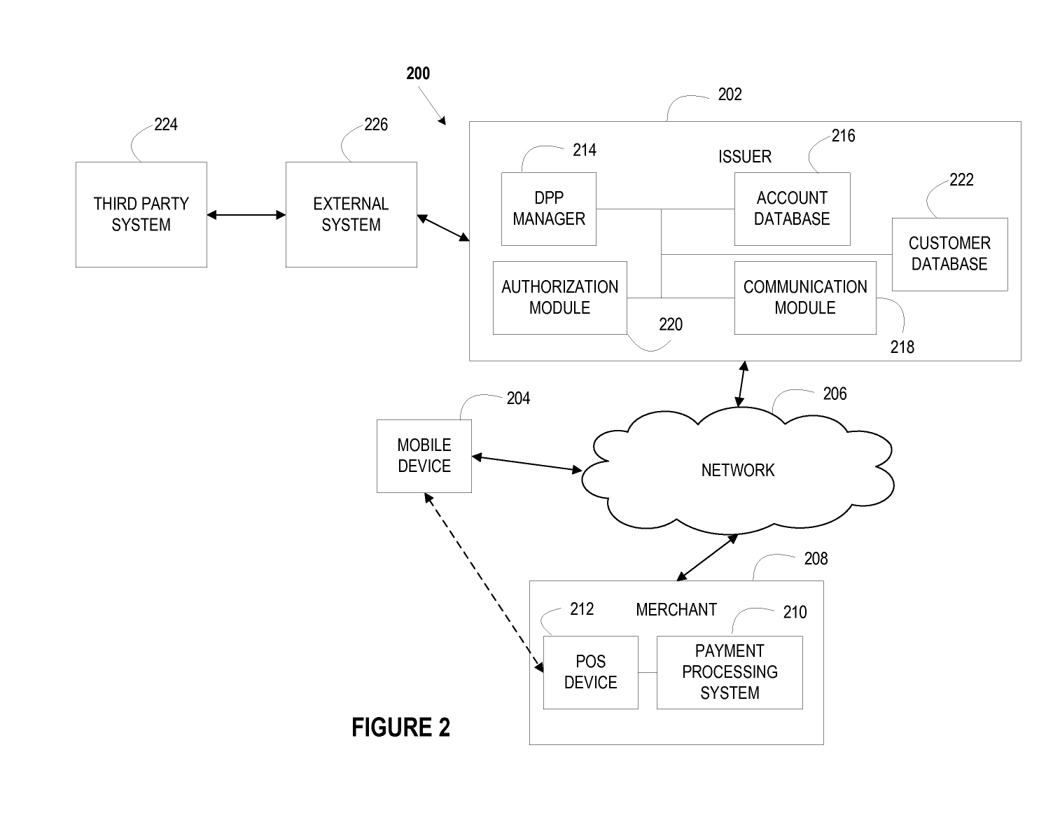

FIG. 2 depicts an example system 200 for use with the mobile wallet shopping companion application. System 200 may include an issuer system 202, a mobile device 204, a network 206, a merchant system 208, an acquisition system, a third party system 224, and an external system 226. The third party system 224 or external system 226 of system 200 may be optional, and where data stored within those systems is included in the issuer system 202, the external system 226 and third party system 224, may not be necessary. In various embodiments, mobile device 204 may be similar to those described above with respect to FIG. 1.

Network 206 may enable communication between mobile device 204, issuer 202, and merchant 208. For example, Network 206 may be one or more of a wireless network, a wired network or any combination of wireless network and wired network. For example, network 206 may include one or more of a fiber optics network, a passive optical network, a cable network, an Internet network, a satellite network, a wireless LAN, a Global System for Mobile Communication (“GSM”), a Personal Communication Service (“PCS”), a Personal Area Network (“PAN”), D-AMPS, Wi-Fi, Fixed Wireless Data, IEEE 802.11b, 802.15.1, 802.11n and 802.11g or any other wired or wireless network for transmitting and receiving a data signal.

In addition, network 206 may include, without limitation, telephone lines, fiber optics, IEEE Ethernet 902.3, a wide area network (“WAN”), a local area network (“LAN”), or a global network such as the Internet. Also network 206 may support an Internet network, a wireless communication network, a cellular network, or the like, or any combination thereof. Network 206 may further include one network, or any number of the example types of networks mentioned above, operating as a stand-alone network or in cooperation with each other. Network 206 may utilize one or more protocols of one or more network elements to which they are communicatively coupled. Network 206 may translate to or from other protocols to one or more protocols of network devices. Although network 206 is depicted as a single network, it should be appreciated that according to one or more embodiments, network 206 may comprise a plurality of interconnected networks, such as, for example, the Internet, a service provider's network, a cable television network, corporate networks, and home networks.

Issuer system 202 may include, for example, a dynamic payment packet (DPP) manager 214, an account database 216, a communication module 218, an authorization module 220, and a customer database 222. DPP manager 214 may generate, maintain, and provide information relating to the payments in a commercial system. In various embodiments, DPP manager 214 may be integrated into issuer system 202 as depicted in FIG. 2. DPP manager 214 may also be a third-party system (not shown) that works in cooperation with issuer system 202 to generate, maintain, and provide data for payments in a commercial system. Account database 216 may maintain information relating to the accounts of customers associated with an issuer. As referred to herein, an issuer may include, for example, a credit card issuer, or any other issuer of tokens or other dynamic payment packets for payment in a commercial system 200. Account database 216 may also include an association of payment data with respective customers. For example, account database 216 may include an association of a token “123456” with account number “1234 5678 9012 3456,” which belongs to John Q. Cardholder. As will be described in more detail below, account database 216 may be accessed for authorizing transactions and or payment requests.

Communication module 218 may enable communication between the components of system 200. Communication module 218 may include hardware, software, and firmware that may enable communication between an issuer system 202 and other components of system 200 using network 206, for example.

Authorization module 220 may include business logic used to determine whether a transaction or payment request should be authorized. For example, authorization module 220 may include executable programs that determine whether a DPP is associated with the correct mobile device 204 and/or issuer account and whether the DPP is used within the limiting parameters before authorizing a particular transaction. Authorization module 220 may cooperate with communication module 218 to communicate authorization decisions to merchant 208 and/or mobile device 204.

Customer database 222 may include additional data elements that may be combined with payment credentials to enhance the post-transaction experience. These additional data elements could be part of a data packet of an authorized transaction itself (and stored within the issuer system 202) or they may be stored separately in another data packet (e.g., a token issued from an external system 226 or a third party system 224).

Merchant 208 may include a Point of Sale (PoS) device 212 and a payment processing system 210. In various embodiments, PoS 212 may be any device that may receive NFC communication, for example and can be utilized to process payment transactions. For example, PoS 212 may be similar to PoS system 600 as shown and described in FIG. 6 below. PoS device 212 may be for example, PoS devices made by VeriFone® and/or any other like devices. As illustrated in FIG. 2 by the dotted line connecting mobile device 304 to PoS device 212, mobile device 204 may be communicatively coupled with PoS device 212 using near field communication, or NFC. A PoS device 212 may also be any device capable of receiving and transmitting payment and transaction information. By way of example, payment options may include mobile contactless payments, remote electronic payments, and person-to-person payments. In an example embodiment, PoS device 212 may be capable of utilizing standardized transmission protocols, for example but not by way of limitation, ISO/IEC 14443 A/B, ISO/IEC 18092, MiFare, FeliCa, tag/smartcard emulation, and the like. Also, PoS device 212 may be able to utilize transmission protocols and methods that are developed in the future using other frequencies or modes of transmission. PoS device 212 may also be backwards-compatible with existing payment techniques, for example RFID. Also, the system may support transmission requirements to meet new and evolving payment standards including internet based transmission triggered by NFC.

Payment processing system 210 may allow merchant 208 to request and process payments, for example. Payment processing system 210 may utilize network 206 to communicate payment requests to issuer system 202 and receive authorization requests. In doing so, payment processing system 210 may transmit information to issuer system 202 using, for example, networks maintained by Visa®, MasterCard®, Discover®, American Express® and the like. Also, payment processing system 210 may be capable of communicating token information using data standards defined by the above-described networks as will be describe in detail below.

In an example embodiment, data associated stored in a third party system 224, external system 226, or customer database 222, may be utilized where a transaction authorization has been approved. After a transaction authorization has been approved, such data (as listed below), may be used to provide a consumer with a transaction-related offer or information. The data and its association to an offer or information may include: data relating to consumer credit cards to enable cross-selling of related products; consumer profile/relevance scores based on historical purchases and/or demographic data (e.g., age, gender, home/work address) to enable targeted offers, marketing, or advertising, delivered through any internet connected device; geolocation data (e.g., of a mobile smartphone or tablet) to enable location-based offers and/or upcoming events or check-ins in real-time or near real-time to purchase; reward or loyalty points credentials (e.g., card rewards, airline/hotel points, virtual currencies) to provide a reward or loyalty bonus or other related offer; product/SKU-level data to enable electronic receipt generation and capture and to provide product-level offers and discounts, warranty and other upsells, and other product level recommendations; social network credentials (e.g., Facebook, Twitter, LinkedIn) to enable social network offers, such as offers relating to particular activity with the social network (e.g., the broadcasting, sharing, and/or viewing of a purchase, including, but not limited to, merchant location, purchase item, purchase amount, merchant name, products purchaser, offers redeemed, rewards earned or redeemed, and payment card brand/type); prior transaction data to enable targeted advertisements, offers, or recommendation associated with a particular consumer's transaction history or a transaction history of a “similar” consumer; and rating or commentary data associated with the merchant or transaction to enable targeted advertisements, offers, or recommendations associated with current and prior ratings or comments of a particular consumer and/or a “similar” consumer.

A “similar” consumer may be determined by the issuer 202 in processing an authorization of a transaction, or it may be determined by an external system 226 or a third party system 224. A “similar” consumer may be a consumer that shares a likeness in data associated with or provided with a transaction. By way of example, a “similar” consumer may be determined to be a consumer who has transaction history data like the transaction history data associated with the consumer making a current transaction. In other examples, a “similar” consumer may have related ratings, demographic data, credit or banking data, geolocation data, rewards or loyalty data, and/or social networking data.

The additional data described above may be provided by the issuer or manager of the payments 202, or by a third party system 224 or an external system 226. The payment can also be shared with a third party system 224 or external system 226, enabling them to provide consumers with an enhanced commercial experience. Security of consumer data and payment credentials is maintained as the payments and/or offers are of limited use and encrypted.

In an example embodiment, the mobile wallet shopping companion application may be used to provide offers, advertisements, and/or suggestions to a user. These offers, advertisements, and/or suggestions may be contextually related to transactions made, and may include discounts, advertising, coupons, or any other offer. As disclosed above, the offers may also be based on transaction history, frequency, location, and/or time of day. The offers may also be based on a user's indicated desires or the location of a user. Information related to the offer may be received from an NFC antenna or over any other data connection.

For example, a user could use the mobile device to purchase a pair of pants and the system 200, including the issuer 202, external system 226, and third party system 224, alone or in combination with a point of sale (PoS) device, could present an advertisement or offer to purchase a matching shirt, belt, and/or socks. In other various embodiments, a user may use a mobile device to make a purchase at a specific merchant and the system 200 may present an advertisement or offer to a consumer based on the specific merchant, a merchant location, and/or an amount spent at a specific merchant. For example, a user may make a purchase at a women's clothing store and the system 200 could present an advertisement or offer related to a women's shoe store. As another example, a user may make a purchase at a gas station and the system may present an advertisement or offer related to a convenient store on the gas station premises. Additionally, a user may make a high-end purchase at a merchant specializing in furniture and the system 200 may present an advertisement or offer related to a high-end merchant specializing in rugs. As another example, a user may be located at a shopping center, and the system 200 may determine that the user has purchased breakfast four hours ago at the shopping center but has not made a transaction for lunch. Accordingly, the system may present suggestions and/or offers for lunch at or close to the shopping center.

The PoS device may transmit purchase information to the mobile device 204. The software on the mobile device 204 may utilize the phone's data connection to download additional information or offers. As an example and not by way of limitation, the software may automate post-transaction purchases via an online merchant—(e.g. cables from an online retailer may be promoted or offered following a purchase at a large retail store), and optionally provide a user an option to select a related product the user would like to purchase from a list of options—this may provide a reduced merchandise selection that is presumably more relevant. Additionally, the offers may be selected by incorporating information from other sources, for example using previously shown offers, past user transactions, consumer preference settings, geographic travel patterns, or any other information. The offers may also be presented when transactions are identified through other methods, such as using scanned receipts, photographs of purchased products, downloaded transaction records, or other ways to identify a product or service purchased by a user. The software may further present a display the effect of an offer to a user's statement in real-time, or either before or after the offer is accepted or rejected.

In an example embodiment, discounts, advertising, coupons, or any other offer may be presented on the mobile device 204. In example embodiments, the software may present a related or complementary product advertisement. Also, the software may present offers or follow-on pitches related to a purchase or transaction. Additionally, the software may provide budgeting information, credit limit information, alternative warranty offers, and/or alternative purchase terms such as an offer for a payment plan or dynamic term loan for a given purchase. The software may also allow downloads and/or presentation of additional materials related to a transaction, such as receipts, warranty information, and/or product manuals. In addition, the software may allow a user to “erase” a transaction at any point after making it by using rewards points. For example, a user who makes a qualifying purchase and has enough rewards points may choose to use their reward points to credit their statement for the amount of a purchase. More specifically, a user may pay for a hotel stay totaling $347.23 and his or her points may have been usable towards travel. That user could choose to immediately credit his or her statement for $347.23 effectively paying for the hotel stay with points. The software may allow for other real-time uses of reward points and/or card-linked offers, (e.g. “spend [x] and we'll take [$y] off your credit card statement”), and may allow for a real time message broadcast notifying the user of any savings.

In example embodiments, system 200 may provide budgeting functionality. The issuer 202 may provide real-time information to a mobile device 204 regarding transactions, for example, the software may display to a user the amount of money spent in a given category or at a given location.

In an example embodiment, the system 200 may allow for social networking functionality. In some embodiments, a user may “check-in” to a location. Also, the software may enable social network updates, postings, or other functionality based on a “check-in” or purchase.

Also, the software and attachment may allow a number of options to a user. For example, the system 200 may provide a user, thought a mobile device 204, the option to the user to use Financial institution transaction history; Loyalty cards; On-line mobile commerce; Deals/Offers; Coupons; Gift Cards; Insurance Cards; Store Passwords; Provisioning for other credit cards; Driver's licenses; Peer to Peer payments—tap two attachments together to transfer payment; Check in when you enter the store; Social Media check in, notice of what was bought, etc.; Product information from tapping on an item; Real time display of upsell and cross sell items; Warranty Upsell (optionally utilizing SKU-level data); Manuals for product (optionally utilizing SKU-level data); Receipts (optionally utilizing SKU-level data); and/or Accepting NFC payments.

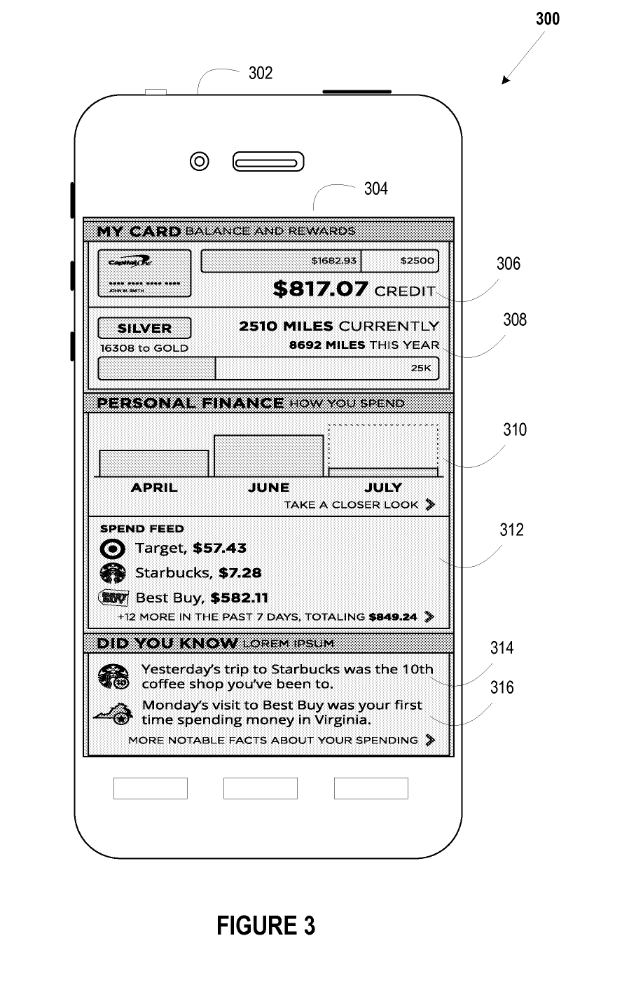

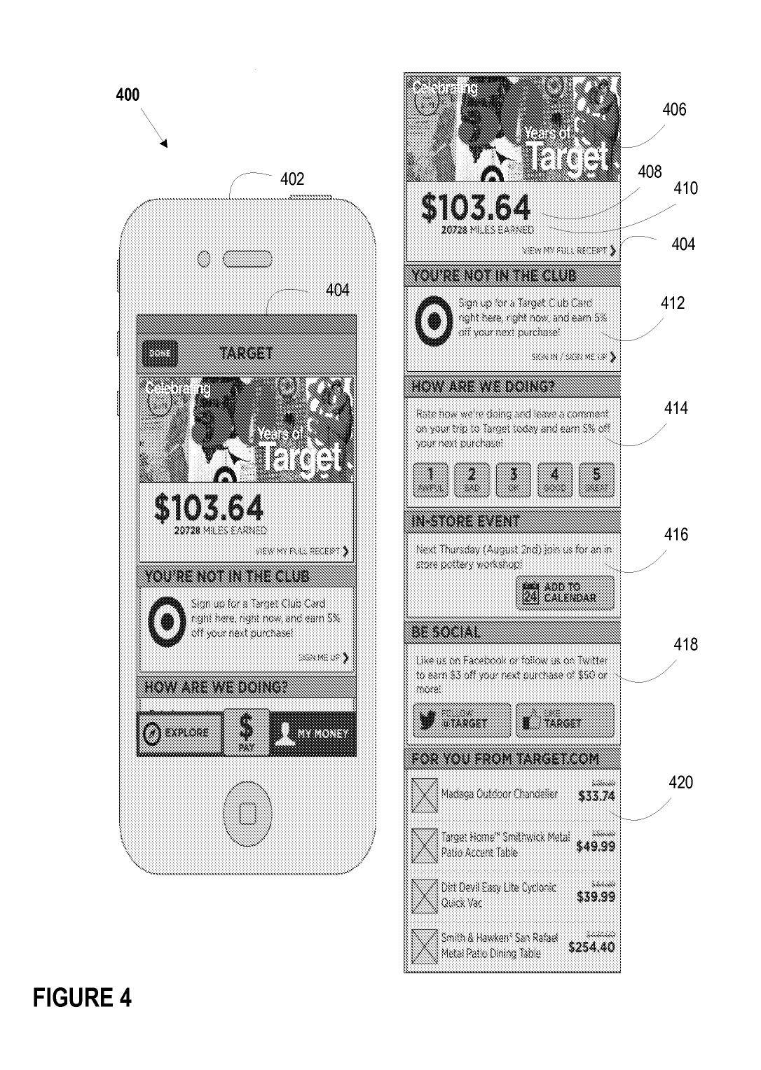

FIGS. 3 and 4 provide example displays associated with the disclosed embodiments. The system 300 of FIG. 3 provides a mobile device 302 and a display 304. The display 304 provides numerous information including, for example credit data 306, rewards data 308, budgeting data 310, transaction data by merchant 312, transaction data by milestones associated with a particular merchant 314, transaction data associated with geolocation data of a transaction 316. By way of example, the system 300 may additionally provide offers, rewards, surveys, feedback, discounts, or the like associated with any of the presented information.

For example, if a user of the mobile device 302 were to select a particular merchant displayed on the screen 304, a variety of options may be presented. The user may be able to rate or comment on the merchant, be notified of upcoming events associated with the merchant (and subsequently add any upcoming event to an electronic calendar on the mobile device 302), view any deals or coupons associated with the merchant (which may be particular to that user associated with the mobile device 302, or general to any user), follow that merchant through social media, or sign up for a loyalty program associated with that merchant and link a particular card to that loyalty program.

FIG. 4 illustrates an example embodiment of the system 400 includes a mobile device 402 having a display 404. The display 404 includes various data such as, for example, merchant data 406, transaction data including receipt data 408, rewards data 410, loyalty data 412, rating data 414, merchant event data 416, merchant social media data 418, and offer/promotion/“similar” consumer data 420. By way of example the data provided in the display 404 of FIG. 4 may be presented either in response to a request from the user of the mobile device 404 or directly after a financial transaction.

The information on the display 404 may be based in part from the user's prior financial transaction in a certain financial account and/or the user's prior financial transactions with a certain merchant. Additional information not shown in FIG. 3 or 4 may include, by way of example, a message presented on the display 404 indicating that the user of the mobile device 402 may want to browse or purchase products from Store B based on the user's transactions with Store A. This determination may be made, for example, because Store B is determined to be a store frequented by “similar” users or users who also frequent Store A. Additionally, the geolocation of a store may be a factor in determining which store may be displayed as Store B. Should the mobile device 402 of the user be determined to be in the vicinity of Store B, deals, rewards, offers, or the like, associated with the user's financial account and/or Store B may be pushed to the mobile device 402. Merchant ratings may also be used to determine a new Store B, where a ratings interface is displayed to the user 404 of the mobile device 402 following a transaction.

Should the user of the mobile device 402 decide to follow the merchant using social media, snippets of the merchant's social media presence may be presented to the user on the display 404 of the mobile device 402. These snippets may include offers, deals, promotions, or the like. Furthermore, related to social media, the user of the mobile device 302 may be presented with fun facts relating to transaction history, such as “Yesterday's trip to Starbucks was the 10^{th} coffee shop you've been to,” or “Monday's visit to Best Buy was your first time spending money in Virginia.” The user may be able to share this fact on social media, which may be stored in a third party system 224 or an external system 226 (or alternatively in a customer database 222). The user facts associated with transaction may be parsed for general information associated with the user's spending habits, such as frequenting a particular restaurant a certain number of times or buying goods from a certain group of vendors. This information may be mined across all users and may include spending analytics. As such rewards and deals may be pushed to a user based on achievements/milestones that they have reached and/or financial history. These rewards or deals may be pushed by a merchant or through a rewards broker system (i.e., an external system 226). Additionally, a user may be able to leave comments by interacting with the display 404 of the mobile device 402 and similarly, the user may be able to read tips or comments left by other users who have interacted with a particular merchant.

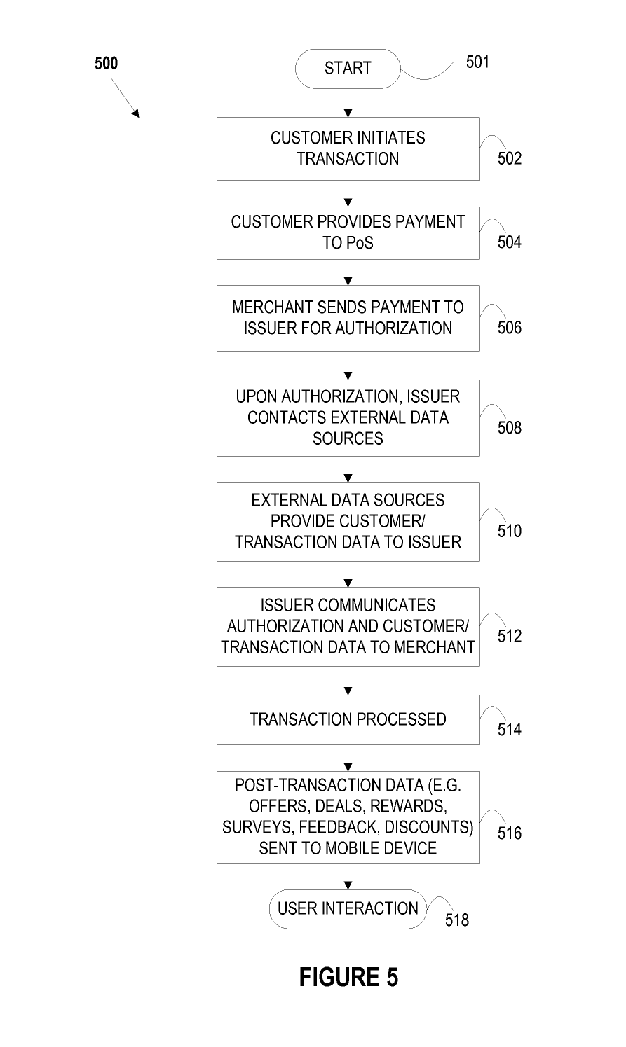

FIG. 5 depicts an example method 500 for providing a mobile wallet shopping companion application. Method 500 may begin in block 501.

In block 502, a customer may initiate a transaction. In various embodiments, a customer may “tap” the mobile device to a PoS device, for example to initiate a request for a token at the time of a transaction. A customer may also initiate a transaction by requesting a token through a mobile payments application using a mobile device. Also, a transaction of FIG. 5 may be may be initiated as a simple credit card swipe transaction, or any other smartcard transaction with a PoS device.

In block 504, a payment associated with a transaction may be accessed from an account associated with a customer's mobile device. For example, a token may be transferred from the mobile device to the PoS device for processing at an issuer, as illustrated in FIG. 2.

In block 506, a merchant may then send the payment to the issuer for authorization for example, as described with respect to FIG. 6. Customer may provide the token to a PoS device. For example, the merchant may send a token to the issuer using a communication network and/or various communications similar to those described in FIG. 3. As noted above, the token provided may also represent simple account information such as the information that would be transferred by a credit card swipe transaction.

In block 508, upon authorization of the payment in the transaction, the issuer may contact external data sources. Additionally, or in lieu of the external data sources, the issuer may consult an internal customer database. The authorization may include a verification of a token and/or transaction utilizing the token. For example, the issuer may use the token to look up the account of the customer and determine whether the transaction should be authorized. The token provided may also represent simple account information such as the information that would be transferred by a credit card swipe transaction. The issuer and/or token manager may also check the token against certain parameters to determine, for example, whether the transaction complies with certain parameters or the token has expired. In various embodiments, the issuer and/or token manager may receive and utilize location information or identification information associated with the customer's mobile device to determine whether to authorize the transaction. For example, the issuer and/or token manager may receive and utilize the MAC address of a mobile device and/or the merchant location to determine whether to authorize the transaction.

The external data sources accessed in block 508 may include creditor system, such as those associated with Visa®, MasterCard®, Discover®, or American Express®, a financial institution system, a merchant system, a social networking system, a rewards/loyalty system, a rating system, or any system related to the data disclosed in the embodiments.

In block 510, the systems related to the external data sources may provide customer or transaction specific data to the issuer. By way of example, and as disclosed previously, this data may be any offer, rating, survey, event, social networking, deal, discount, reward, loyalty data, or the like. This data may then be combined with the transaction authorization.

In block 512, the issuer may then communicate the combined authorization and customer/transaction specific data to the merchant. In block 514, the transaction may be processed and in block 516, the customer/transaction specific data and authorization (i.e., post-transaction data) may be transmitted to the mobile device as illustrated in, for example, FIGS. 3 and 4. Once the data has been transmitted to the mobile device, the user may interact with the data, block 518, as illustrated in FIGS. 3 and 4 and the user interaction may then be communicated to the external data systems (e.g., third party system 224, external system 226, customer database 222).

FIG. 6 depicts an example Point of Sale (PoS) device 600. PoS device 600 may provide the interface at what a customer or end user makes a payment to the merchant in exchange for goods or services. PoS device 600 may include and/or cooperate with weighing scales, scanners, electronic and manual cash registers, electronic funds transfer at point of sale (EFTPOS) terminals, touch screens and any other wide variety of hardware and software available for use with PoS device 600. PoS device 600 may be a retail point of sale system and may include a cash register and/or cash register-like computer components to enable purchase transactions. PoS device 600 also may be a hospitality point of sale system and include computerized systems incorporating registers, computers and peripheral equipment, usually on a computer network to be used in restaurant, hair salons, hotels or the like. PoS device 600 may be a wireless point of sale device similar to a PoS device described herein or, for example a tablet computer that is configured to operate as a PoS device, including for example, software to cause the tablet computer to execute point of sale functionality and a card reader such as for example the Capital One® SparkPay card reader, the Square® reader, Intuit's® GoPayment reader, or the like. PoS device 600 also may be a cloud-based point of sale system that can be deployed as software as a service, which can be accessed directly from the Internet using, for example, an Internet browser.

Referring to FIG. 6, an example PoS device 600 is shown. PoS device 600 may include a controller 602, a reader interface 604, a data interface 606, a smartcard reader 608, a magnetic stripe reader 610, a near-field communications (NFC) reader 612, a power manager 614, a keypad 616, an audio interface 618, a touchscreen/display controller 620, and a display 622. Also, PoS device 600 may be coupled with, integrated into or otherwise connected with a cash register/retail enterprise system 624.

In various embodiments, Controller 602 may be any controller or processor capable of controlling the operations of PoS device 600. For example, controller 602 may be a Intel® 2nd Generation Core™ i3 or i5 or Pentium™ G850 processor or the like. Controller 602 also may be a controller included in a personal computer, smartphone device, tablet PC or the like.

Reader interface 604 may provide an interface between the various reader devices associated with PoS device 600 and PoS device 600. For example, reader interface 604 may provide an interface between smartcard reader 608, magnetic stripe reader 610, NFC reader 612 and controller 602. In various embodiments, reader interface 604 may be a wired interface such as a USB, RS232 or RS485 interface and the like. Reader interface 604 also may be a wireless interface and implement technologies such as Bluetooth, the 802.11(x) wireless specifications and the like. Reader interface 604 may enable communication of information read by the various reader devices from the various reader devices to PoS device 600 to enable transactions. For example, reader interface 604 may enable communication of a credit or debit card number read by a reader device from that device to PoS device 600. In various embodiments, reader interface 604 may interface between PoS device 600 and other devices that do not necessarily “read” information but instead receive information from other devices.

Data interface 606 may allow PoS device 600 to pass communicate data throughout PoS device and with other devices including, for example, cash register/retail enterprise system 624. Data interface 606 may enable PoS device 600 to integrate with various customer resource management (CRM) and/or enterprise resource management (ERP) systems. Data interface 606 may include hardware, firmware and software that make aspects of data interface 606 a wired interface. Data interface 606 also may include hardware, firmware and software that make aspects of data interface 606 a wireless interface. In various embodiments, data interface 606 also enables communication between PoS device other devices.

Smartcard reader 608 may be any electronic data input device that reads data from a smart card. Smartcard reader 608 may be capable of supplying an integrated circuit on the smart card with electricity and communicating with the smart card via protocols, thereby enabling read and write functions. In various embodiments, smartcard reader 608 may enable reading from contact or contactless smart cards. Smartcard reader 608 also may communicate using standard protocols including ISO/IEC 7816, ISO/IEC 14443 and/or the like or proprietary protocols.

Magnetic stripe reader 610 may be any electronic data input device that reads data from a magnetic stripe on a credit or debit card, for example. In various embodiments, magnetic stripe reader 610 may include a magnetic reading head capable of reading information from a magnetic stripe. Magnetic stripe reader 610 may be capable of reading, for example, cardholder information from tracks 1, 2, and 3 on magnetic cards. In various embodiments, track 1 may be written on a card with code known as DEC SIXBIT plus odd parity and the information on track 1 may be contained in several formats (e.g., format A, which may be reserved for proprietary use of the card issuer; format B; format C-M which may be reserved for us by ANSI subcommittee X3B10; and format N-Z, which may be available for use by individual card issuers). In various embodiments, track 2 may be written with a 5-bit scheme (4 data bits plus 1 parity). Track 3 may be unused on the magnetic stripe. In various embodiments, track 3 transmission channels may be used for transmitting dynamic data packet information to further enable enhanced token-based payments.

NFC reader 612 may be any electronic data input device that reads data from a NFC device. In an exemplary embodiment, NFC reader 612 may enable Industry Standard NFC Payment Transmission. For example, the NFC reader 612 may communicate with a NFC enabled device to enable two loop antennas to form an air-core transformer when placed near one another by using magnetic induction. NFC reader 612 may operate at 13.56 MHz or any other acceptable frequency. Also, NFC reader 612 may enable a passive communication mode, where an initiator device provides a carrier field, permitting answers by the target device via modulation of existing fields. Additionally, NFC reader 612 also may enable an active communication mode by allowing alternate field generation by the initiator and target devices.

In various embodiments, NFC reader 612 may deactivate an RF field while awaiting data. NFC reader 612 may receive communications containing Miller-type coding with varying modulations, including 100% modulation. NFC reader 612 also may receive communications containing Manchester coding with varying modulations, including a modulation ratio of approximately 10%, for example. Additionally, NFC reader 612 may be capable of receiving and transmitting data at the same time, as well as checking for potential collisions when the transmitted signal and received signal frequencies differ.

NFC reader 612 may be capable of utilizing standardized transmission protocols, for example but not by way of limitation, ISO/IEC 14443 A/B, ISO/IEC 18092, MiFare, FeliCa, tag/smartcard emulation, and the like. Also, NFC reader 612 may be able to utilize transmission protocols and methods that are developed in the future using other frequencies or modes of transmission. NFC reader 612 also may be backwards-compatible with existing payment techniques, such as, for example RFID. Also, NFC reader 612 may support transmission requirements to meet new and evolving payment standards including internet based transmission triggered by NFC. In various embodiments, NFC reader 612 may utilize MasterCard's® PayPass and/or Visa's® PayWave and/or American Express'® ExpressPay systems to enable transactions.

Although not shown and described, other input devices and/or readers, such as for example, barcode readers and the like are contemplated.

Power manager 614 may be any microcontroller or integrated circuit that governs power functions of PoS device 600. Power manager 614 may include, for example, firmware, software, memory, a CPU, a CPU, input/output functions, timers to measure intervals of time, as well as analog to digital converters to measure the voltages of the main battery or power source of PoS device 600. In various embodiments, Power manager 614 remain active even when PoS device 600 is completely shut down, unused, and/or powered by the backup battery. Power manager 614 may be responsible for coordinating many functions, including, for example, monitoring power connections and battery charges, charging batteries when necessary, controlling power to other integrated circuits within PoS device 600 and/or other peripherals and/or readers, shutting down unnecessary system components when they are left idle, controlling sleep and power functions (on and off), managing the interface for built-in keypad and trackpads, and/or regulating a real-time clock (RTC).

Keypad 616 may any input device that includes a set of buttons arranged, for example, in a block or pad and may bear digits, symbols and/or alphabetical letters. Keypad 616 may be a hardware-based or mechanical-type keypad and/or implemented in software and displayed on, for example, a screen or touch screen to form a keypad. Keypad 616 may receive input from a user that pushed or otherwise activates one or more buttons on keypad 616 to provide input.

Audio interface 618 may be any device capable of providing audio signals from PoS device 600. For example, audio interface may be a speaker or speakers that may produce audio signals. In various embodiments, audio interface 618 may be integrated within PoS device 600. Audio interface 618 also may include components that are external to PoS device 600.

Touchscreen/display control 620 may be any device or controller that controls an electronic visual display. Touchscreen/display control 620 may allow a user to interact with PoS device 600 through simple or multi-touch gestures by touching a screen or display (e.g., display 622). Touchscreen/display control 620 may be configured to control any number of touchscreens, including, for example, resistive touchscreens, surface acoustic wave touchscreens, capacitive touchscreens, surface capacitance touchscreens, projected capacitance touchscreens, mutual capacitance touchscreens, self-capacitance touchscreens, infrared grid touchscreens, infrared acrylic projection touchscreens, optical touchscreens, touchscreens based on dispersive signal technology, acoustic pulse recognition touchscreens, and the like. In various embodiments, touchscreen/display control 620 may receive inputs from the touchscreen and process the received inputs. Touchscreen/display control 620 also may control the display on PoS device 600, thereby providing the graphical user interface on a display to a user of PoS device 600.

Display 622 may be any display suitable for a PoS device. For example, display 622 may be a TFT, LCD, LED or other display. Display 622 also may be a touchscreen display that for example allows a user to interact with PoS device 600 through simple or multi-touch gestures by touching a screen or display (e.g., display 622). Display 622 may include any number of touchscreens, including, for example, resistive touchscreens, surface acoustic wave touchscreens, capacitive touchscreens, surface capacitance touchscreens, projected capacitance touchscreens, mutual capacitance touchscreens, self-capacitance touchscreens, infrared grid touchscreens, infrared acrylic projection touchscreens, optical touchscreens, touchscreens based on dispersive signal technology, acoustic pulse recognition touchscreens, and the like. In various embodiments, 622 may receive inputs from control gestures provided by a user. Display 622 also may display images, thereby providing the graphical user interface to a user of PoS device 600.

Cash register/retail enterprise system 624 may me any device or devices that cooperate with PoS device 600 to process transactions. Cash register/retail enterprise system 624 may be coupled with other components of PoS device 600 via, for example, a data interface (e.g., data interface 606) as illustrated in FIG. 6. Cash register/retail enterprise system 624 also may be integrated into PoS device 600.

In various embodiments, cash register/retail enterprise system 624 may be a cash register. Example cash registers may include, for example, mechanical or electronic devices that calculate and record sales transactions. Cash registers also may include a cash drawer for storing cash and may be capable of printing receipts. Cash registers also may be connected to a network to enable payment transactions. Cash registers may include a numerical pad, QWERTY or custom keyboard, touch screen interface, or a combination of these input methods for a cashier to enter products and fees by hand and access information necessary to complete the sale.

In various embodiments, cash register/retail enterprise system 624 may comprise an retail enterprise system and/or a customer relationship management system. Retail enterprise system 624 may enable retain enterprises to manage operations and performance across a retail operation. Retail enterprise system 624 may be a stand-alone application in, for example, individual stores, or may be interconnected via a network. Retail enterprise system 624 may include various point of sale capabilities, including the ability to, for example, customize and resize transaction screens, work with a “touch screen” graphical user interface, enter line items, automatically look up price (sales, quantity discount, promotional, price levels), automatically compute tax, VAT, look up quantity and item attribute, display item picture, extended description, and sub-descriptions, establish default shipping services, select shipping carrier and calculate shipping charges by weight/value, support multi-tender transactions, including cash, check, credit card, and debit card, accept food stamps, place transactions on hold and recall, perform voids and returns at POS, access online credit card authorizations and capture electronic signatures, integrate debit and credit card processing, ensure optional credit card discounts with address verification, support mix-and-match pricing structure, discount entire sale or selected items at time of sale, add customer account, track customer information, including total sales, number of visits, and last visit date. issue store credit, receive payment(s) for individual invoices, process deposits on orders, search by customer's ship-to address, create and process layaway, back orders, work orders, and sales quotes, credit items sold to selected sales reps, view daily sales graph at the PoS, view and print journals from any register, preview, search, and print journals by register, batch, and/or receipt number, print X, Z, and ZZ reports, print receipts, invoices, and pick tickets with logos/graphics, print kit components on receipt, reprint receipts, enter employee hours with an integrated time clock function, and/or sell when the network/server is down with an offline PoS mode. Retail enterprise system 624 also may include inventory control and tracking capabilities, reporting tools, customer management capabilities, employee management tools, and may integrate with other accounting software.

In various embodiments cash register/retail enterprise system 624 may be a hospitality PoS. In such embodiments, retail enterprise system 624 may include hospitality PoS software (e.g., Aloha PoS Restaurant software from NCR®, Micros® RES and Symphony software and the like), hospitality management software, and other hardware and software to facilitate hospitality operations.

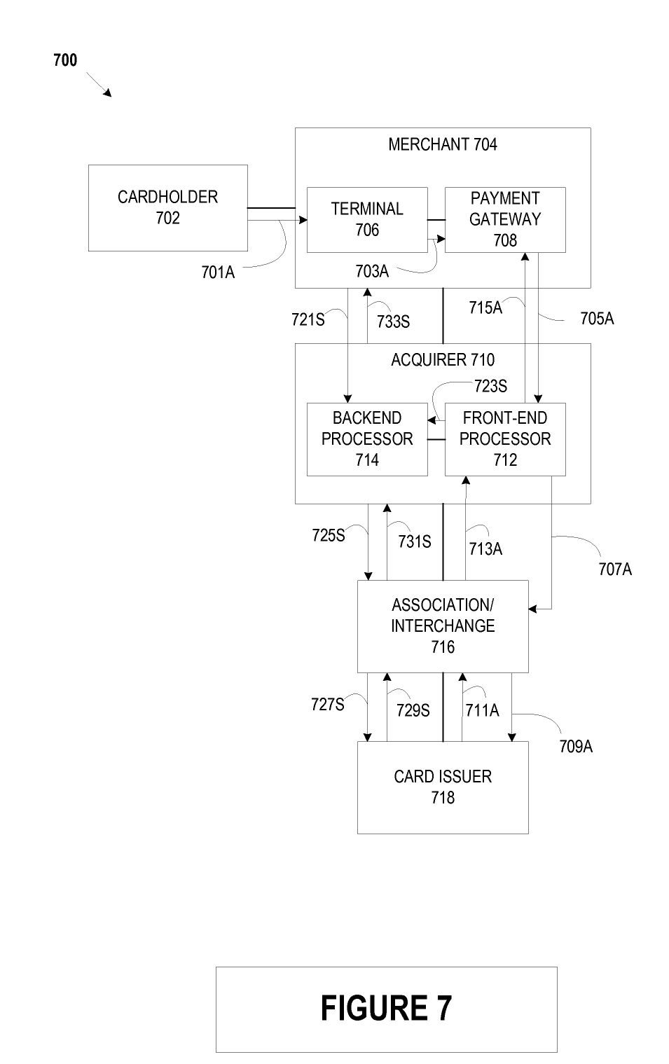

FIG. 7 illustrates an example system 700 and method for card authorization. In various embodiments, system 700 may enable and/or be used to transmit data relating to a mobile wallet companion application. For example, an issuer may transmit mobile wallet companion data in response to an authorization request. In various embodiments, an issue may use additional networks to transmit mobile wallet companion application data in response to an authorization request. As shown and described in FIG. 7, merchants, cardholders and financial institutions may be connected with a card association network to enable secure transactions and timely payments. System 700 may include a cardholder 702, merchant 704, Acquirer 710, Association/Interchange 716, and card issuer 718.

Cardholder 702 may be any card holder, including a credit card holder, debit card holder, stored value card holder and the like. Cardholder 702 may possess a plastic card or carry a device (e.g., a mobile device) that securely stores card credentials and is capable of transmitting the card credentials to, for example, a PoS terminal (e.g., terminal 706). Cardholder 702 may interact with a merchant (e.g., merchant 704) by presenting a card or card credentials to a terminal (e.g., terminal 706).

Merchant 704 may be any merchant that accepts payment from a cardholder, for example. Merchant 704 may be any retailer, service provider, business entity, or individual that accepts payments. Merchant 704 may include software, firmware and hardware for accepting and/or processing payments. For example, as illustrated in FIG. 7, merchant 704 may include a terminal 706 and a payment gateway 708. Terminal 706 and payment gateway 708 may comprise the physical or virtual device(s) used by merchant 704 to communicate information to front-end processor 712 of acquirer 710. Terminal 706 may be similar to PoS system 700 as shown and described in Figure Y. In various embodiments, payment gateway 708 may be an e-commerce application service provider service that authorizes payments for merchants. As such, payment gateway 708 may be a virtual equivalent of a PoS terminal and interface with, for example, a billing system of merchant 704 and pass data to front-end processor 712 of acquirer 710.

Acquirer 710 may be, for example, a financial institution or bank, that holds the contract for providing payment processing services to merchant 704. Merchant 704 may have a merchant account that may serve as a contract under which Acquirer 710 may extend a line of credit to a merchant who wishes to accept, for example, credit card transactions. As shown in FIG. 7, Acquirer 710 may be associated with front-end processor 712 and back-end processor 714.

In various examples, front-end processor 712 may be a platform that card terminal 706 and/or payment gateway 708 communicate with when approving a transaction. Front-end processor 712 may include hardware, firmware, and software to process transactions. Front-end processor 712 may be responsible for the authorization and capture portion of credit card transaction. Front-end processor 712 also may include additional front-end platform interconnections to support, for example, ACH and debit transactions.

Backend processor 714 may be a platform that takes captured transactions from front-end processor 712 and settles them through an Interchange system (e.g., association/interchange 716). Back-end processor 714 may generate, for example, daily ACH files for merchant settlement. Back-end processor 714 also may handle chargeback handling, retrieval request and monthly statements.

Association/interchange 716 may be the consumer payment system whose members are the financial institutions that issue payment cards and/or sign merchant to accept payment cards. Example associations/interchanges 716 may include, Visa®, MasterCard®, and American Express®. Association/interchange 716 may include one or more computer systems and networks to process transactions.

Issuer 718 may be a financial institution that issues payment cards and maintains a contract with cardholders for repayment. In various embodiments, issuer 718 may issue credit, debit, and/or stored value cards, for example. Example issuers may include, Capital One, Bank of America, Citibank, and the like.

In various embodiments, processing a payment card transaction may involves two stages: (1) authorization and (2) clearing and settlement. Authorization may refer to an electronic request that is sent through various parties to either approve or decline the transaction. Clearing and Settlement may refer to settlement of the parties' settle accounts to enable the parties to get paid.

During authorization, cardholder 702 may present payment card as payment (701A) at merchant 704 PoS terminal 706, for example. Merchant 704 may enter card into a physical PoS terminal 706 or submit a credit card transaction to a payment gateway 708 on behalf of cardholder 702 via secure connection from a Web site, retail location, or a wireless device.

Payment gateway 708 may receive the secure transaction information (703A) and may pass the secure transaction information (705A) via a secure connection to the merchant acquirer's 710 front-end processor 712.

Front-end processor 712 may submit the transaction (707A) to association/interchange 716 (e.g., a network of financial entities that communicate to manage the processing, clearing and settlement of credit card transactions). Association/interchange 716 may route the transaction (709A) to the customer's Issuer 718. Issuer 718 may approve or decline the transaction and passes the transaction results back (711A) through association/interchange 716. Association/interchange then may relay the transaction results (713A) to front-end processor 712.

Front-end processor 712 may relay the transaction results (715A) back to the payment gateway 708 and /or terminal 706. Payment gateway 708 may store the transaction results and sends them to merchant 704. Merchant 704 may receive the authorization response and complete the transaction accordingly.

During settlement, merchant 704 may deposit the transaction receipt (721S) with acquirer 710 via, for example, a settlement batch. Captured authorizations may be passed (723S) from front-end processor 712 to the back-end processor 714 for settlement. Back-end processor may generates ACH files for merchant settlement. Acquirer may submit settlement files (725S, 727S) to Issuer 718 for reimbursement via association/interchange 716. Issuer 718 may post the transaction and pay merchant 704 (729S, 731S, 733S).

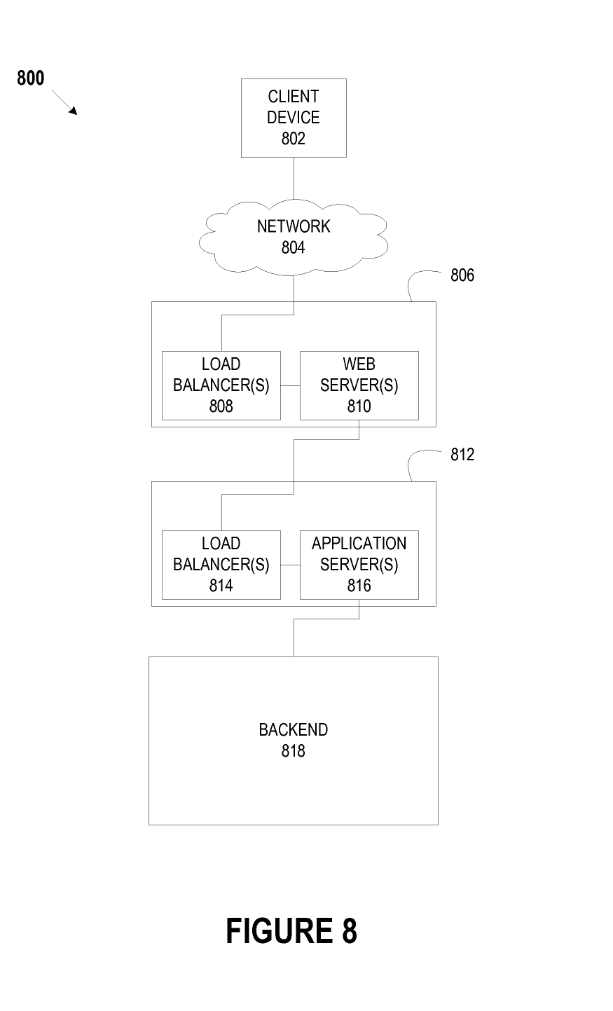

FIG. 8 depicts an example system 800 that may enable a financial institution, for example, to provide network services to its customers. For example, system 800 may enable a financial institution to provide a mobile wallet companion application to its customers. As shown in FIG. 8, system 800 may include a client device 802, a network 804, a front-end controlled domain 806, a back-end controlled domain 812, and a backend 818. Front-end controlled domain 806 may include one or more load balancers 808 and one or more web servers 810. Back-end controlled domain 812 may include one or more load balancers 814 and one or more application servers 816.

Client device 802 may be a network-enabled computer: As referred to herein, a network-enabled computer may include, but is not limited to: e.g., any computer device, or communications device including, e.g., a server, a network appliance, a personal computer (PC), a workstation, a mobile device, a phone, a handheld PC, a personal digital assistant (PDA), a thin client, a fat client, an Internet browser, or other device. The one or more network-enabled computers of the example system 800 may execute one or more software applications to enable, for example, network communications.

Client device 802 also may be a mobile device: For example, a mobile device may include an iPhone, iPod, iPad from Apple® or any other mobile device running Apple's iOS operating system, any device running Google's Android® operating system, including for example, Google's wearable device, Google Glass, any device running Microsoft's Windows® Mobile operating system, and/or any other smartphone or like wearable mobile device.

Network 804 may be one or more of a wireless network, a wired network, or any combination of a wireless network and a wired network. For example, network 804 may include one or more of a fiber optics network, a passive optical network, a cable network, an Internet network, a satellite network, a wireless LAN, a Global System for Mobile Communication (GSM), a Personal Communication Service (PCS), a Personal Area Networks, (PAN), D-AMPS, Wi-Fi, Fixed Wireless Data, IEEE 802.11b, 802.15.1, 802.11n, and 802.11g or any other wired or wireless network for transmitting and receiving a data signal.

In addition, network 804 may include, without limitation, telephone lines, fiber optics, IEEE Ethernet 902.3, a wide area network (WAN), a local area network (LAN) or a global network such as the Internet. Also, network 804 may support an Internet network, a wireless communication network, a cellular network, or the like, or any combination thereof. Network 804 may further include one network, or any number of example types of networks mentioned above, operating as a stand-alone network or in cooperation with each other. Network 804 may utilize one or more protocols of one or more network elements to which they are communicatively couples. Network 804 may translate to or from other protocols to one or more protocols of network devices. Although network 804 is depicted as a single network, it should be appreciated that according to one or more embodiments, network 804 may comprise a plurality of interconnected networks, such as, for example, the Internet, a service provider's network, a cable television network, corporate networks, and home networks.

Front-end controlled domain 806 may be implemented to provide security for backend 818. Load balancer(s) 808 may distribute workloads across multiple computing resources, such as, for example computers, a computer cluster, network links, central processing units or disk drives. In various embodiments, load balancer(s) 810 may distribute workloads across, for example, web server(S) 816 and/or backend 818 systems. Load balancing aims to optimize resource use, maximize throughput, minimize response time, and avoid overload of any one of the resources. Using multiple components with load balancing instead of a single component may increase reliability through redundancy. Load balancing is usually provided by dedicated software or hardware, such as a multilayer switch or a Domain Name System (DNS) server process.

Load balancer(s) 808 may include software that monitoring the port where external clients, such as, for example, client device 802, connect to access various services of a financial institution, for example. Load balancer(s) 808 may forward requests to one of the application servers 816 and/or backend 818 servers, which may then reply to load balancer 808. This may allow load balancer(s) 808 to reply to client device 802 without client device 802 ever knowing about the internal separation of functions. It also may prevent client devices from contacting backend servers directly, which may have security benefits by hiding the structure of the internal network and preventing attacks on backend 818 or unrelated services running on other ports, for example.

A variety of scheduling algorithms may be used by load balancer(s) 808 to determine which backend server to send a request to. Simple algorithms may include, for example, random choice or round robin. Load balancers 808 also may account for additional factors, such as a server's reported load, recent response times, up/down status (determined by a monitoring poll of some kind), number of active connections, geographic location, capabilities, or how much traffic it has recently been assigned.

Load balancers 808 may be implemented in hardware and/or software. Load balancer(s) 808 may implement numerous features, including, without limitation: asymmetric loading; Priority activation: SSL Offload and Acceleration; Distributed Denial of Service (DDoS) attack protection; HTTP compression; TCP offloading; TCP buffering; direct server return; health checking; HTTP caching; content filtering; HTTP security; priority queuing; rate shaping; content-aware switching; client authentication; programmatic traffic manipulation; firewall; intrusion prevention systems.

Web server(s) 810 may include hardware (e.g., one or more computers) and/or software (e.g., one or more applications) that deliver web content that can be accessed by, for example a client device (e.g., client device 802) through a network (e.g., network 804), such as the Internet. In various examples, web servers, may deliver web pages, relating to, for example, online banking applications and the like, to clients (e.g., client device 802). Web server(s) 810 may use, for example, a hypertext transfer protocol (HTTP or sHTTP) to communicate with client device 802. The web pages delivered to client device may include, for example, HTML documents, which may include images, style sheets and scripts in addition to text content.

A user agent, such as, for example, a web browser, web crawler, or native mobile application, may initiate communication by making a request for a specific resource using HTTP and web server 810 may respond with the content of that resource or an error message if unable to do so. The resource may be, for example a file on stored on backend 818. Web server(s) 810 also may enable or facilitate receiving content from client device 802 so client device 802 may be able to, for example, submit web forms, including uploading of files.

Web server(s) also may support server-side scripting using, for example, Active Server Pages (ASP), PHP, or other scripting languages. Accordingly, the behavior of web server(s) 810 can be scripted in separate files, while the actual server software remains unchanged.

Load balancers 814 may be similar to load balancers 808 as described above.

Application server(s) 816 may include hardware and/or software that is dedicated to the efficient execution of procedures (e.g., programs, routines, scripts) for supporting its applied applications. Application server(s) 816 may comprise one or more application server frameworks, including, for example, Java application servers (e.g., Java platform, Enterprise Edition (Java EE), the .NET framework from Microsoft®, PHP application servers, and the like). The various application server frameworks may contain a comprehensive service layer model. Also, application server(s) 816 may act as a set of components accessible to, for example, a financial institution or other entity implementing system 800, through an API defined by the platform itself. For Web applications, these components may be performed in, for example, the same running environment as web server(s) 810, and application servers 816 may support the construction of dynamic pages. Application server(s) 816 also may implement services, such as, for example, clustering, fail-over, and load-balancing. In various embodiments, where application server(s) 816 are Java application servers, the web server(s) 816 may behaves like an extended virtual machine for running applications, transparently handling connections to databases associated with backend 818 on one side, and, connections to the Web client (e.g., client device 802) on the other.

Backend 818 may include hardware and/or software that enables the backend services of, for example, a financial institution or other entity that maintains a distributes system similar to system 800. For example, backend 818 may include, a system of record, online banking applications, a rewards platform, a payments platform, a lending platform, including the various services associated with, for example, auto and home lending platforms, a statement processing platform, one or more platforms that provide mobile services, one or more platforms that provide online services, a card provisioning platform, a general ledger system, and the like. Backend 818 may be associated with various databases, including account databases that maintain, for example, customer account information, product databases that maintain information about products and services available to customers, content databases that store content associated with, for example, a financial institution, and the like. Backend 818 also may be associated with one or more servers that enable the various services provided by system 800.

In the preceding specification, various preferred embodiments have been described with references to the accompanying drawings. It will, however, be evident that various modifications and changes may be made thereto, and additional embodiments may be implemented, without departing from the broader scope of the invention as set forth in the claims that follow. The specification and drawings are accordingly to be regarded as an illustrative rather than restrictive sense.

1. A mobile wallet shopping companion system comprising:
a transaction manager that generates payment data and provides the payment data to a customer for user with a transaction;
an authorization module that receives, via a network, the transaction data and the payment data;
a database that stores, and is capable of providing, transaction specific data in response to an authorized transaction, wherein the transaction specific data is customer specific;
a processor that processes the authorization and transaction specific data; and
an output that transmits, via a network, the authorization and transaction specific data.

2. The system of claim 1, wherein the transaction specific data is transmitted to a mobile device of the customer.

3. The system of claim 2, wherein the transaction specific data is provided to a native application on the mobile device.

4. The system of claim 1, wherein the authorization and transaction specific data are transmitted via the same network.

5. The system of claim 1, wherein the authorization and transaction specific data are transmitted via the different networks.

6. The system of claim 5, wherein the authorization data is transmitted via an authorization network and the transaction specific data is transmitted via a wireless network.

7. The system of claim 1, wherein the transaction specific data includes an offer.

8. The system of claim 7, wherein the payment data relates to a first merchant and the transaction specific data relates to a second merchant.

9. The system of claim 7, wherein the payment and the transaction specific data relate to the same merchant.

10. The system of claim 1, wherein the processor uses location data to process the transaction specific data.

11. A method, comprising:
generating, using a transaction manager, payment data;
providing the payment data to customer for user with a transaction;
receiving, at an authorization module via a network, the transaction data and the payment data;
storing in a database transaction specific data in response to an authorized transaction, wherein the transaction specific data is customer specific;
processing, using a processor, the authorization and transaction specific data; and
transmitting, via a network, the authorization and transaction specific data.

12. The method of claim 11, further comprising transmitting the transaction specific data to a mobile device of the customer.

13. The method of claim 12, further comprising providing the transaction specific data to a native application on the mobile device.

14. The method of claim 11, further comprising transmitting the authorization and transaction specific data via the same network.

15. The method of claim 11, further comprising transmitting the authorization and transaction specific data via the different networks.

16. The method of claim 15, wherein the authorization data is transmitted via an authorization network and the transaction specific data is transmitted via a wireless network.

17. The method of claim 11, wherein the transaction specific data includes an offer.

18. The method of claim 17, wherein the payment data relates to a first merchant and the transaction specific data relates to a second merchant.

19. The method of claim 17, wherein the payment and the transaction specific data relate to the same merchant.

20. The method of claim 11, further comprising using location data to process the transaction specific data.
